(19) United States
(12) Patent Application Publication
(10) Pub. No.: US 2019/0039872 A1
(43) Pub. Date: Feb. 7, 2019

(54) WEIGHTED FUNNEL

(71) Applicant: TPG Plastics LLC, Willowbrook, IL (US)

(72) Inventor: Patrick Owen Kelly, Lockport, IL (US)

(21) Appl. No.: 16/053,595

(22) Filed: Aug. 2, 2018

Related U.S. Application Data
(60) Provisional application No. 62/540,288, filed on Aug. 2, 2017.

(51) Int. Cl. B67C 11/06

(52) U.S. Cl. CPC B67C 11/066

(57) ABSTRACT

A weighted funnel, the weight assisting to keep the funnel substantially upright, the weight comprising a periphery defining an internal void, the void receiving the neck of the funnel. The neck of the funnel is threaded externally while the weight is threaded internally (in the void) so that the threads engage each other, securing the weight in place. Other embodiments allow for alternate methods of securing the weight.

### CROSS REFERENCE TO RELATED APPLICATIONS

This application claims benefit of U.S. Provisional Application No. 62/540,288, filed on Aug. 2, 2017, which is herein incorporated by reference in its entirety.

### BACKGROUND

A common difficulty in the use of funnels is the need for the operator to use one or both hands to stabilize a funnel while he could use the occupied hand or hands to perform other tasks. Despite efforts to address the above problem, it persists. The present innovation discloses new and novel funnel and method of using said funnel.

### SUMMARY

The present specification relates to use of an anchoring weight to anchor a funnel atop a receptacle. The downward pressure of the weight will keep the funnel in place while the receptacle is filled.

The diameter of the receptacle opening is immaterial so long as it does not exceed the diameter of the weight. Thus the funnel may be used to fill containers over a wide range of sizes.

As the funnel is not threaded into the receptacle, it may be removed from the receptacle fairly quickly should the need arise.

Other advantages of the present innovation will become apparent from the following detailed description when considered in light of the accompanying drawings.

Note that in interpreting the present invention the term on may be taken to constitute on top of, within, adjacent to, in contact with otherwise in close proximity to and securely attached to.

### BRIEF DESCRIPTION OF THE DRAWINGS

The various features, advantages and other uses of the present embodiments will become more apparent by referring to the following detailed description and drawing in which:

FIG. 1 is an isometric view of the funnel absent the weight;

FIG. 2 is a view of the weight;

FIG. 3 is an isometric view of the funnel coupled to the weight;

FIG. 4 is an isometric view of an alternative funnel; and

FIG. 5 is an isometric view of an extended spout that may be coupled to the funnel of FIG. 4.

### DETAILED DESCRIPTION

The present application relates generally to a weighted funnel. Such will be described with particular reference to the embodiments detailed herein. However, it will be understood that it also finds application in other usage scenarios and is not necessarily limited to the aforementioned application.

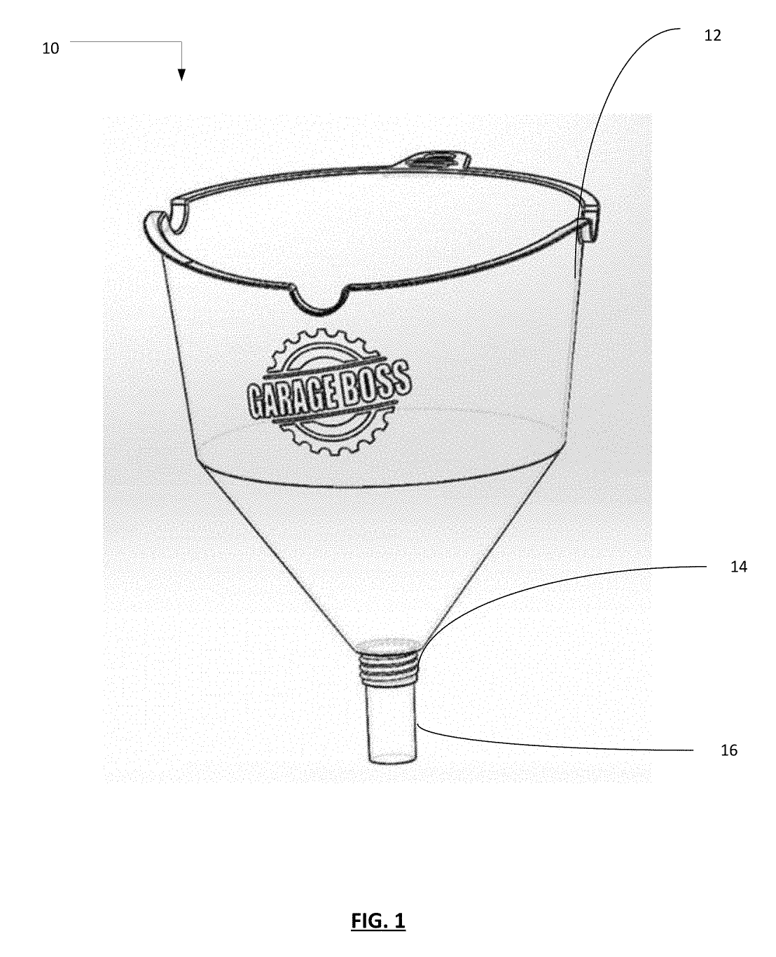

FIGS. 1-3 are directed toward an embodiment in which a funnel is secured to a weight that encompasses the neck of the funnel in order to allow the force of gravity on the weight to secure the funnel in place over a receptacle in order to allow for the hands-free funneling of substances. In one embodiment, the substance may be a liquid. In another, the substance may be a granular solid. Embodiments in which other substances may be efficiently moved through use of a funnel are also contemplated though not explicitly named.

FIG. 1 shows a funnel (10) according to an embodiment of the present invention, the funnel (10) including a body (12) and a neck or spout (16), operative to receive substances at the widest part of its body (12) and direct it to the narrower neck or spout (16), wherein the neck of the funnel (16) has external threading (14) and the external threading (14) is operative to engage threading of an associated weight (not shown).

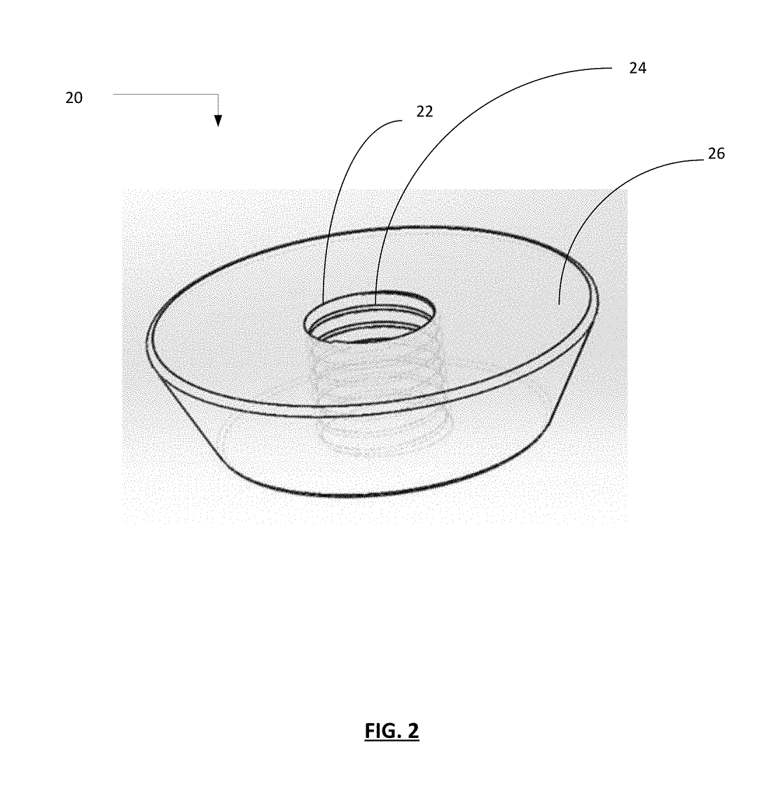

FIG. 2 shows a weight (20) consisting of a void (22) and a periphery or skirt (26). The weight (20) has internal threading (24) along the wall of the void (22) which can engage the external threading (14) of the funnel (10) of FIG. 1.

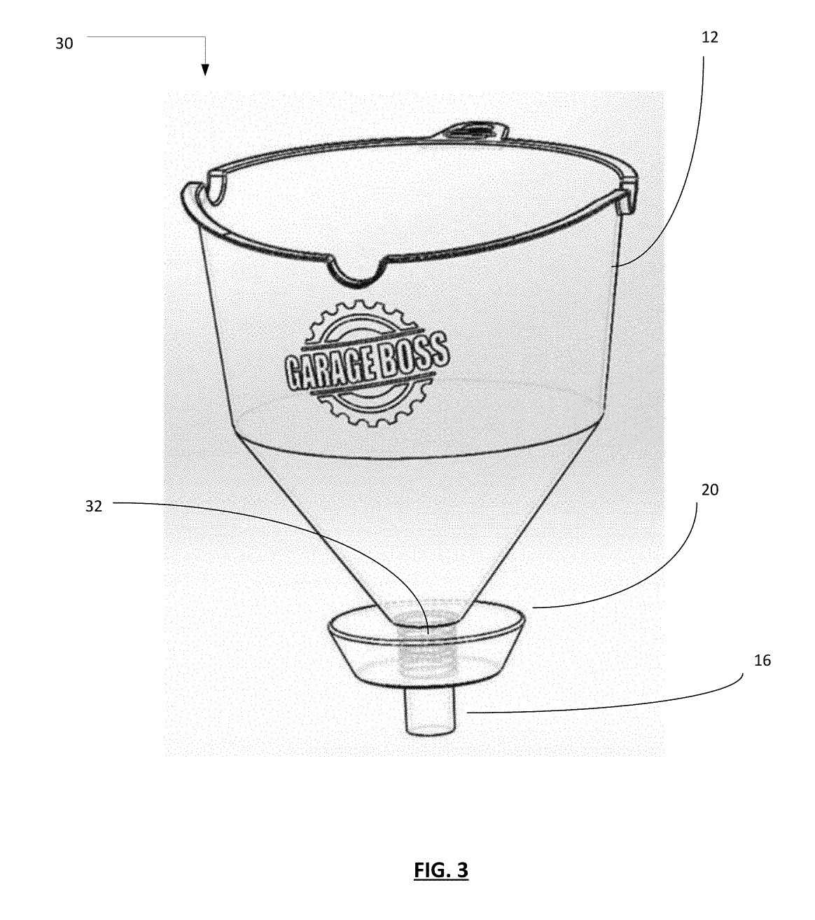

FIG. 3 shows a funnel (10) as contemplated in FIG., 1 coupled to a weight (20), clearly displaying the engagement (32) of the external threading (14) of the funnel (10) with the internal threading (24) of the weight (20). The funnel (10) is removably coupled to the weight (20) about the neck (16) of the funnel (10) so as to secure, by means of gravity, the funnel (10) in a substantially upright position on a receptacle.

According to an aspect of the invention, the weight (20) may be attached to the funnel (10) by means other than those depicted in FIGS. 1-3. For example, in one embodiment, the weight (20) may be coupled to the neck (16) of the funnel (10) by means of a rubber gasket that occupies its void (22). In another embodiment, the weight (20) may consist of two separate parts joined by hinges, the two parts being operative to fasten securely around the neck (16) of the funnel (10). In another embodiment, the weight (20) may be removably coupled (e.g., insertable) within the body (12) of the funnel (10), the weight (20) being contoured to the shape of the funnel (10), wherein the weight (20) has at least one aperture which allows substances to pass through it. In another embodiment, the weight (20) may be housed within the neck (16) of the funnel (10), wherein the weight (20) has at least one aperture which allows substances to pass through it. In another embodiment, the funnel (30) and weight (20), instead of being removably coupled together, may be constructed, machined, or molded from a single piece of material.

According to another aspect of the invention, the funnel may be coupled to an extended spout which is in turn coupled to a weight comprising a weight that encompasses its neck in order to allow the force of gravity on the weight to secure the funnel in place over a receptacle in order to allow for the hands-free funneling of liquid while the spout of the funnel extends past the threaded neck of the funnel into a receptacle.

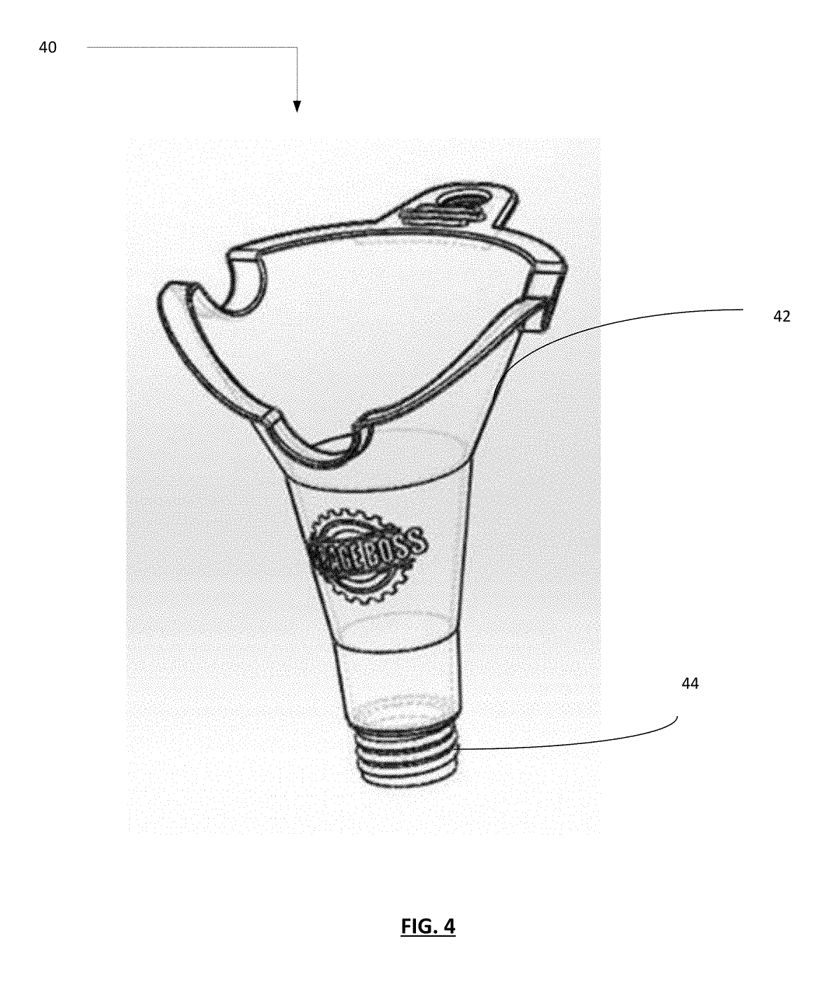

FIG. 4 shows an embodiment of the funnel (40) in which the funnel (40) is operative to receive substances at the widest part of its body (42) and direct them to the narrower neck (44), the neck ending in a spout. The spout has by external threading (44) operative to engage threading located on the uppermost portion of the extended spout (50).

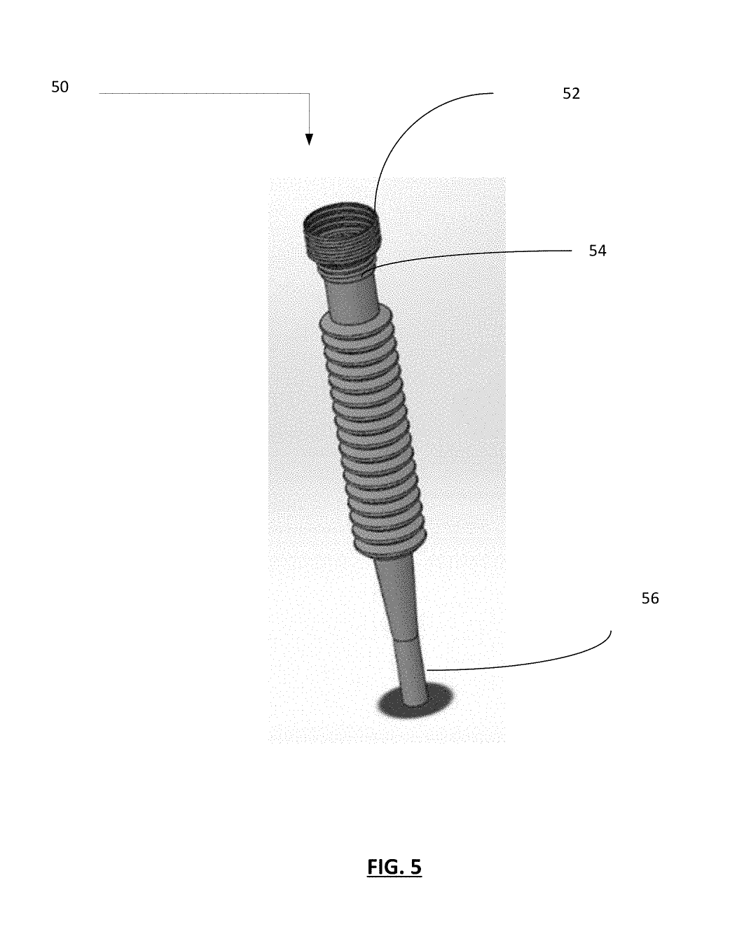

FIG. 5 depicts another embodiment having an extended spout (50). The uppermost portion of the extended spout (50) consists of threading (52) operative to engage threading located on the spout at the end of the neck (44) of the funnel (40). It will be understood that the threading located on the spout at the end of the neck (44) of the funnel (40) may cover all or part of the neck (44). The extended spout (50) includes, below the threading (52) operative to engage threading located on the neck (44) of the funnel (40), an attachment means (54) operative to attach to the weight (20). In one instance, the attachment means (54) may be threading operative to engage internal threading (24) located in the void (22) of the weight (20). The funnel (40) is coupled to the extended spout (50) and the extended spout is coupled to the weight (20) such that the weight (20) secures, by means of gravity, the funnel (40) in a substantially upright position on a receptacle while the extended spout (56) extends into a receptacle.

According to another embodiment, the extended spout and weight may be permanently coupled while the funnel and extended spout are removably coupled. The alternative attachment methods described above for the weight are equally applicable to the embodiment depicted by FIGS. 4 and 5.

While recited characteristics and conditions of the invention have been described in connection with certain embodiments, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1-18. (canceled)

19. A funnel system, the system comprising:
a funnel, the funnel having a body and a neck with a weight interface, and operative to direct substances received at the body to the neck; and
a weight, the weight including a void and a surrounding periphery, and configured to encompass the neck through the void at the weight interface; wherein
the funnel at the weight interface is securable to the weight at the void, whereby the funnel is anchorable by means of gravity on the weight in a substantially upright position on a receptacle.

20. The funnel system according to claim 19, wherein the void is straight-walled.

21. The funnel system according to claim 19, wherein the void has a fixed size.

22. The funnel system according to claim 19, wherein the weight interface and the void are straight-walled.

23. The funnel system according to claim 19, wherein the weight interface is immediately adjacent the body.

24. The funnel system according to claim 19, wherein the weight interface is externally threaded, the void is internally threaded, and the funnel at the weight interface is threadable with the weight at the void.

25. The funnel system according to claim 19, wherein the funnel at the weight interface is securable to the weight at the void by means of a rubber gasket that occupies the void.

26. The funnel system according to claim 19, wherein the weight consists of two separate parts joined by hinges, the two parts being operative to fasten securely around the funnel at the weight interface.

27. The funnel system according to claim 19, wherein the funnel and the weight are constructed, machined, or molded from a single piece of material.

28. A funnel system, the system comprising:
a funnel, the funnel having a body and a neck with an extended spout interface, and operative to direct substances received at the body to the neck;
an extended spout for the funnel, the extended spout having a funnel interface and a weight interface; and
a weight, the weight including a void and a surrounding periphery, and configured to encompass the extended spout through the void at the weight interface; wherein
the funnel at the extended spout interface is securable to the extended spout at the funnel interface and the extended spout at the weight interface is securable to the weight at the void, whereby the funnel is anchorable by means of gravity on the weight in a substantially upright position on a receptacle while the extended spout extends into the receptacle.

29. The funnel system according to claim 28, wherein the void is straight-walled.

30. The funnel system according to claim 28, wherein the void has a fixed size.

31. The funnel system according to claim 28, wherein the weight interface and the void are straight-walled.

32. The funnel system according to claim 28, wherein the funnel interface is at an uppermost location on the extended spout, and the weight interface is immediately adjacent the funnel interface.

33. The funnel system according to claim 28, wherein the extended spout interface is externally threaded, the funnel interface is internally threaded, and the funnel at the extended spout interface is threadable with the extended spout at the funnel interface.

34. The funnel system according to claim 28, wherein the weight interface is externally threaded, the void is internally threaded, and the extended spout at the weight interface is threadable with the weight at the void.

35. The funnel system according to claim 28, wherein the extended spout at the weight interface is securable to the weight at the void by means of a rubber gasket that occupies the void.

36. The funnel system according to claim 28, wherein the weight consists of two separate parts joined by hinges, the two parts being operative to fasten securely around the extended spout at the weight interface.

37. The funnel system according to claim 28, wherein the extended spout and the weight are constructed, machined, or molded from a single piece of material.

38. The funnel system according to claim 28, wherein the extended spout and the weight are permanently coupled.
